(19) United States
(12) Patent Application Publication
(10) Pub. No.: US 2002/0078619 A1
(43) Pub. Date: Jun. 27, 2002

(54) Tube Lure

(76) Inventor: Michael E. Hurtle JR., Elkhart, IN (US)

Correspondence Address: Michael W. Starkweather, Jones, Waldo, Holbrook & McDonough, Suite 1500, 170 South Main Street, Salt Lake City, UT, 84101, US

(21) Appl. No.: 10/082,700

(22) Filed: Feb. 25, 2002

Related U.S. Application Data
(63) Continuation-in-part of application No. 09/329,758, filed on Jun. 10, 1999.

(51) Int. Cl. A01K 85/00

(52) U.S. Cl. 43/42.39

(57) ABSTRACT

A tube lure, comprising a flexible tube body having a cavity therein. Additionally, there is a head that is rounded and enclosed, and has a first thickness. There is also a wall, extending from the head, and a skirt, extending from the wall. An additional feature of the invention is to provide a jig head, having a conformally shaped weight that fits within the cavity without stretching the flexible tube body, including a hook. The hook has a barb, at one end of the hook for holding fish thereon. The hook also has a shank that is straight and extends from the hook and extends through the weight. The hook has an eye, attached to an opposite end of the hood from the barb. Additionally, the hook has a neck, extending from the shank and to the eye, in a direction equal to the shank, having a length that is equal to or greater than the first thickness. A further feature of the invention is to provide the weight with a front end that is blunt, and could be rounded with a first radius. The weight also has a length, extending from the front end with a portion of a cross-sectional thickness equal to at most twice the radius, the cross-sectional thickness is about the same as a cross-sectional thickness of the cavity.

### BACKGROUND OF THE INVENTION

1. Field of the Invention

This invention relates to soft artificial fishing lures. In particular, there is a tube lure that includes a jig head and flexible tube body that performs better than the prior art.

2. Description of the Related Art

The background art shows a variety of designs for soft plastic fishing lures, which are made to simulate the appearance of aquatic life that is eaten by your intended catch, in this case, all varieties of bass. Examples of patents related to the present invention are as follows, and each patent is herein incorporated by reference for the supporting teachings:

U.S. Pat. No. 4,887,377, is a shad type fish bait with nose cavity in its leading end for receiving a lead jig head in order to enhance the natural appearance and motion of the bait for greater appeal to fish.

U.S. Pat. No. 4,907,364, is a is a hard plastic jig head that includes a cavity on its back side to receive the forward end of a soft pliable body member mounted on a retainer and the barb of a fish hook. The jig head is placed at the rear bottom of the plastic bait to resist the tendency of the lure to rotate in the water and to provide a desired horizontal orientation as the lure is retrieved.

U.S. Pat. No. 5,524,377, is a jig trailer fishing lure made of a synthetic material capable of absorbing water and fish attractant liquids. The lure is capable of completely drying out between uses yet quickly re-acquires a life-like texture when immersed in water. U.S. Pat. No. 4,790,100, is a flexible fishing lure designed for use as a trailer on a host of lures or with a jig head. The tube lure has a body with at least one set of legs that fit inside the tube lure body. A jig head is inserted through the set of legs and tube body.

U.S. Pat. No. 5,649,384, is a weighted jig fish lure with an orientation device for plastic bait to be attached thereto.

U.S. Pat. No. 4,596,086, is a weed guard for incorporation within a fishing jig. Three is an elongated flexible plastic member with a rounded head portion and a cylindrical portion interconnected by a central neck portion.

The foregoing patents reflect the state of the art of which the applicant is aware and are tendered with the view toward discharging applicants' acknowledged duty of candor in disclosing information that may be pertinent in the examination of this application. It is respectfully stipulated, however, that none of these patents teach or render obvious, singly or when considered in combination, applicants' claimed invention.

3. Problems With the Prior Art

Bass fishing is a sophisticated multi-million dollar industry. There are hundreds of tournaments held each weekend all over the United States, some awarding prizes totaling over one-hundred thousand dollars. Often, the only difference between standing in the money circle and going home with only stories about the one that got away, are a few ounces of fish. With so small of a weight determining such large winnings, the goal is not to catch the most fish, but catching lunkers, Mr. Big Bass.

One main problem is that there are so many fishermen and tournaments every weekend, all of the easy to reach fishing places have already been explored and the fish have already seen the same old lures many times.

Recently popular bait on the Pro Circuit is the TUBE lure. It is shaped as the word suggests, a rubberized hollow tube with its head closed and its tail shredded, looking like tentacles on a squid. This lure has solving the one problem of being too familiar of a lure, so Ol' Bucket Mouth will not have seen many of these before.

The designers of the tube lure, however, overlooked how the lure would be used. Current jig heads for fishing the tube lure have proved cumbersome at best and often down right frustrating. For example, current jig heads have a many shapes, but most all have a standard larger round portion at the head and some taper back along the hook. The problem occurs when you need larger weights like 3/8 or 1/2 ounce to pitch or flip the lure into lily pads or brush piles. With the standard 3 inch lure, the larger jig heads will bulge the sides of the lure outward. This bulging creates a stretching of the rubberized material. When the material is stretched, contact with weeds, rocks or brush will tear the material much faster than if the material was not stretched. Additionally, most professionals use scented or salt impregnated lures, which will leach out of the material much faster when placed under the added bulging. Leaching will cause the lure to discolor at the jig head location. Additionally, both situations, leaching and tearing, cause the fisherman to change lures more often than is desired. The more time they spend changing lures the less time they have for catching that one hundred thousand-dollar monster bass.

Additionally, current jig head designs have inadequate eye formations. First, jig eyes are currently designed to be at a sixty or ninety degree angle to the longitudinal axis of the lure body. This is fine for open water fishing or light weeds, but in heavy weeds, this design will grab and catch weeds. Second, the eyes are located too close to the lead head. This short eye, causes the fishing line to be embedded into the lure body, which will cut the lure material from line movement.

Therefore, there is a need for a tube lure jig head that avoids the problems discussed hereinabove.

### SUMMARY OF THE INVENTION

It is a feature of the invention to provide a soft artificial fishing lure. In particular, there is a tube lure that has an integral jig head that performs better than the prior art.

A further feature of the invention is to provide a tube lure, comprising a flexible tube body having a cavity therein. Additionally, there is a head that is rounded and enclosed, and has a first thickness. There is also a wall, extending from the head, and a skirt, extending from the wall.

An additional feature of the invention is to provide a jig head, having a conformally shaped weight that fits within the cavity without stretching the flexible tube body, including a hook. The hook has a barb, at one end of the hook for holding fish thereon. The hook also has a shank that is straight and extends from the hook and extends through the weight. The hook has an eye, attached to an opposite end of the hood from the barb. Additionally, the hook has a neck, extending from the shank and to the eye, in a direction equal to the shank, having a length that is equal to or greater than the first thickness.

A further feature of the invention is to provide the weight with a front end that imay be blunt, and more particularly that can be rounded with a first radius. The weight also has a length, extending from the front end with a cross-sectional thickness equal to at most twice the radius; the cross-sectional thickness is about the same as a cross-sectional thickness of the cavity.

The invention resides not in any one of these features per se, but rather in the particular combination of all of them herein disclosed and claimed and it is distinguished from the prior art in this particular combination of all of its structures for the functions specified.

There has thus been outlined, rather broadly, the more important features of the invention so that the detailed description thereof that follows may be better understood, and so that the present contribution to the art may be better appreciated. There are, of course, additional features of the invention that will be described hereinafter which would form the subject matter of the claims appended hereto. Those skilled in the art will appreciate that the conception, upon which this disclosure is based, may readily be utilized as a basis for the designing of other structures, methods and systems for carrying out the several purposes of the present invention. I t is important, therefore, that the claims are regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, neither is it intended to be limiting as to the scope of the invention in any way.

Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a side cross-sectional view of the tube lure with jig embodiment.

FIG. 2 is a top cross-sectional view of the embodiment of FIG. 1.

FIG. 3 is a schematic diagram of only the weight from FIG. 1.

It is noted that the drawings of the invention are not to scale. The drawings are merely schematic representations, not intended to portray specific parameters of the invention. The drawings are intended to depict only typical embodiments of the invention, and therefore should not be considered as limiting the scope of the invention. The invention will be described with additional specificity and detail through the use of the accompanying drawings. Like numbering between figures represent like elements.

### Charter by the U.S. Constitution

This disclosure of the invention is submitted in furtherance of the constitutional purposes of the United States Patent Laws “to promote the progress of science and useful arts,” as stated in Article 1, Section 8 of the United States Constitution.

### DETAILED DESCRIPTION OF THE PREFERRED EMBODIMENT

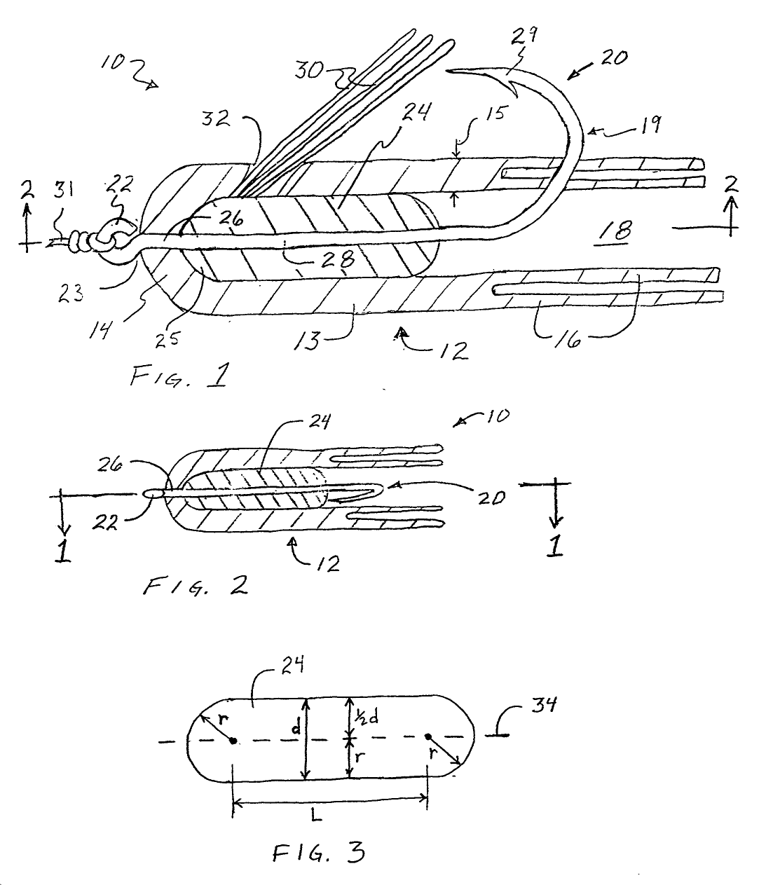

Referring to both FIG. 1 and FIG. 2, there is a side cross-sectional view of the tube lure with jig embodiment. Specifically, there is a tube lure 10 that is made of a tube body 12 and a weighted jig hook 20, also referred to as a jig head. The tube body comprises walls 13, enclosed head 14, wall thickness 15, skirt 16, and cavity 18. All parts of the tube body are made of a rubberized or plasticized material that may be impregnated with scented material or salt, for example.

Jig head 20 has several parts. In particular, there is a hook 19 that has a hook eye 22, neck 26, shank 28, and barb 29. The jig head also has an elongated lead weight 24 with a lead weight front end 25. Hook eye 22 extends through eye-hole 23. Neck 26 has a length that equals or exceeds the tube wall thickness 15. There also may be a weed guard 30 that would extend through the tube body at hole 32, which is made by the fisherman during insertion of the jig head into the tube body. Fishing line 31 attaches to eye 22.

Referring to FIG. 3, there is a schematic diagram of weight 24 from FIG. 1. Hook shaft 28, neck 26 and eye 22 (not shown) all go through centerline 34. Weight 24 roughly forms a barrel-shaped or rod-shaped design, having rounded ends. Specifically, there is a cross-sectional diameter “d”, with 1/2 d forming a radius “r”, which matches the rounded inside surface or cross-sectional diameter of cavity 18. The weight has a main length “L” that extends from one end to the other as illustrated. At each end of length L, there is a rounded cap with radius “r” as illustrated. Therefore the entire length of the weight is equal to the formula of: L+2r or L+d.

Remarks About the Preferred Embodiment

One of ordinary skill in the art of tube lure pitching and flipping into heavy weed or brush cover will realize many advantages from using the preferred embodiment. For example, cylindrically shaped weight 24 has its diameter “d” and radius “r” selected to match the exact dimensions of tube cavity 18. Specifically, tube head 14 is rounded and the radius “r” is selected to match the inner radius of the tube head dimensions. Additionally, weight diameter “d” is selected to match the inner tube diameter.

Because of the close match between the jig weight and the tube's inner cavity dimensions, several problems with the prior art are solved. First, the problem of creating a bulge in the tube body in the head region is eliminated. Thus, the salt impregnated body 13 will not be leached out as fast and not discolor as fast as prior art larger head designs. Second, the front end of the weight 25, resists being pulled through eye hole 23, because its rounded shape offer a larger object to be pulled therethrough versus typical prior art pointed shaped lead heads, which pull through more easily. Third, by increasing the length “L”, the entire mass of the weight will increase without creating the typical bulging from prior art designs that merely increased the front portion of the weight.

A skilled artisan would also realize the advantage of having neck 26 that extends along the center line 34 and equals or exceeds the dimensions of the thickness of tube body 12. First, when pulling tube lure 10 through weeds, line 31 will pull the tube exactly behind it and along the same path that the line follows. The prior art has the line attached on top, near the weed guard, so the line would direct weeds down along the line to be caught between the eye and lure head. Therefore, the present invention can be used in thicker weeds and brush piles than the prior art with less hang-ups and less weed dragging.

A second advantage from having neck 26 is that line 31 does not touch tube body 12. If the eye were buried within nose 14, 1) line 31 would be hitting the sides of hole 23, which would wear away the material faster, and 2) the eye would increase the size of hole 23 and rub on its sides, which would increase the chances of pulling jig head 20 therethrough and also wear out the material sooner.

A skilled artisan would consider it an obvious design change to make the rear end of weight 24 out of most any shape, like squared off or pointed, for example. Any shape would work just so that there is no bulging of walls 13 created therefrom, which would also mean that the overall length could vary from the L+d formula. Additionally, it is obvious that the weight could be much smaller than the cavity and not depart from the intended design features and have the intended advantages discussed above. Moreover, the length “L” section of the weight could also decrease in size, like a cone, if gradual decreased, or stepped if abruptly decreased in size.

Obviously, the angle or orientation of the eye, being vertical and in line with the barb, could be in any orientation and not depart from the scope of the invention.

Also, it is obvious that the head of the weight could have many variations in the shape, like oval or even flat, depending upon the shape of the internal cavity head region and the amount of contact desired between the head cavity region and the weight head region. The key to the weight head region design is to prevent the easy extraction of the weight through the hole made by the eye and neck. Generally, this weight head region can be referred to as a “blunt” shape, meaning not sharp enough to poke through the lure body material as easy as a pointed sharp shape, like a bullet nose weight. Finally, it is obvious that the neck of the hook could be angled to the shank of the hook, like sixty or even ninety degrees relative to the shank.

While the invention has been taught with specific reference to these embodiments, someone skilled in the art will recognize that changes can be made in form and detail without departing from the spirit and the scope of the invention. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by United States Patent is:

1. A tube lure, comprising:
a) a flexible tube body having a cavity therein; and
b) a jig head, having a conformally shaped weight that fits within the cavity without stretching the flexible tube body.

2. The lure of claim 1, wherein the jig head further includes a hook, having:
a) a barb, at one end of the hook for holding fish thereon;
b) a shank, that is straight and extends from the hook and extends through the weight;
c) an eye, attached to an opposite end of the hook from the barb; and
d) a neck, extending from the shank and to the eye, in a direction equal to the shank, having a length that is equal to or greater than the first thickness.

3. The lure of claim 2, wherein the tube body further includes:
a) a head that is rounded and enclosed, and has a first thickness;
b) a wall, extending from the head; and
c) a skirt, extending from the wall.

4. The lure of claim 3, wherein the weight further comprising:
a) a front end that is rounded with a first radius; and
b) a length, extending from the front end with a cross-sectional thickness equal to at most twice the radius, the cross-sectional thickness is about the same as a cross-sectional thickness of the cavity.

3. The lure of claim 1, wherein the weight further comprising:
a) a front end that is blunt in shape; and
b) a length, extending from the front end with a portion of a cross-sectional thickness equal to at most a cross-sectional thickness of the cavity.

6. The lure of claim 5, wherein the jig head further includes a hook, having:
a) a barb, at one end of the hook for holding fish thereon;
b) a shank, that is straight and extends from the hook and extends through the weight;
c) an eye, attached to an opposite end of the hook from the barb; and
d) a neck, extending from the shank and to the eye, in a direction equal to the shank, having a length that is equal to or greater than the first thickness.

7. The lure of claim 6, wherein the tube body further includes:
a) a head that is rounded and enclosed, and has a first thickness;
b) a wall, extending from the head; and
c) a skirt, extending from the wall.

8. The lure of claim 7, wherein the weight further comprising:
a) the front end being rounded with a first radius; and
b) the length having a cross-sectional thickness equal to at most twice the radius, which is at most the same as the cross-sectional thickness of the cavity.

9. A tube lure, comprising:
a) a flexible tube body having a cavity therein, having:
1) a head that is rounded and enclosed, and has a first thickness;
2) a wall, extending from the head; and
3) a skirt, extending from the wall;
b) a jig head, having a conformally shaped weight that fits within the cavity without stretching the flexible tube body, including a hook having:
1) a barb, at one end of the hook for holding fish thereon;
2) a shank, that is straight and extends from the hook and extends through the weight;
3) an eye, attached to an opposite end of the hood from the barb; and
4) a neck, extending from the shank and to the eye, in a direction equal to the shank, having a length that is equal to or greater than the first thickness; and
c) the weight further comprising:
1) a front end that is rounded with a first radius; and
2) a length, extending from the front end with a cross-sectional thickness equal to at most twice the radius, the cross-sectional thickness is about the same as a cross-sectional thickness of the cavity.
